(19) United States
(12) Patent Application Publication
(10) Pub. No.: US 2010/0167158 A1
(43) Pub. Date: Jul. 1, 2010

(54) METHOD FOR PRODUCING A SOLID FUEL FOR FUEL CELLS, SOLID FUEL FOR FUEL CELLS, AND FUEL CELL

(75) Inventor: Koichi Mori, Tokyo (JP)

Correspondence Address: POSZ LAW GROUP, PLC, 12040 SOUTH LAKES DRIVE, SUITE 101, RESTON, VA, 20191, US

(73) Assignee: KURITA WATER INDUSTRIES LTD., Shinjiku-ku, Tokyo (JP)

(21) Appl. No.: 12/451,758

(22) PCT Filed: Jun. 4, 2008
(86) PCT No.: PCT/JP2008/060309

§ 371 Date: Nov. 30, 2009

(30) Foreign Application Priority Data
Jun. 4, 2007 (JP) 2007-148563

(51) Int. Cl. H01M 8/10; C10L 5/00

(52) U.S. Cl. 429/479; 44/530

(57) ABSTRACT

An object of the present invention is to provide a method for producing a highly safe solid fuel for fuel cells having excellent handleability, a highly safe solid fuel for fuel cells having excellent handleability, and a fuel cell using such a solid fuel for fuel cells. In a method for producing a solid fuel for fuel cells in which a coating film is formed on the surface of a porous material containing a fuel for fuel cells, the coating film is formed by polyvinyl alcohol, and the fuel for fuel cells is introduced into the porous material before and/or after formation of the coating film on the surface of the porous material.

### TECHNICAL FIELD

The present invention relates to a method for producing a solid fuel for fuel cells, to a solid fuel for fuel cells, and to a fuel cell.

### BACKGROUND ART

Measures for tackling environmental and resource issues have gained in importance in recent years. Among such measures, the development of fuel cells, which allow generating electric power through direct feeding of water and an organic solvent as a liquid fuel, is being actively pursued. Direct methanol fuel cells using methanol as a liquid fuel, which can generate electric power by supplying methanol directly, without reforming or gasifying it, have in particular a simple structure that can be easily miniaturized and made lightweight. Direct methanol fuel cells, therefore, hold promise as portable power supplies, as a form of distributed power and as consumer power supplies in, for instance, small portable electronic devices, computers and the like.

Such fuel cells that generate electric power through direct feeding of a liquid fuel comprise a stack of plural cells having each a membrane-electrode assembly (MEA) in which a positive electrode (air electrode) and a negative electrode (fuel electrode), on two sides, are bonded via an interposed electrolyte that comprises a solid polymer electrolyte membrane having proton conductivity, the MEA being supported by a separator on the positive electrode side (air electrode side) and a separator on the negative electrode side (fuel electrode side). The separator on the positive electrode side (air electrode side) and the separator on the negative electrode side (fuel electrode side) have the function of feeding an oxidizing gas to the positive electrode (air electrode) and a liquid fuel to the negative electrode (fuel electrode), and of discharging the reaction products that form as a result of the electrochemical reactions that take place between the oxidizing gas and the liquid fuel via the electrolyte.

In a direct methanol fuel cell, thus, a methanol aqueous solution is fed to the negative electrode (fuel electrode) side and air, as an oxidizing gas, is fed to the positive electrode (air electrode) side. Thereupon, methanol and water react at the negative electrode (fuel electrode), generating carbon dioxide and releasing hydrogen ions and electrons, while at the positive electrode (air electrode), oxygen in the air takes up the electrons and hydrogen ions that pass through the electrolyte, to form water and generate an electromotive force in an external circuit. The generated water is discharged out of the positive electrode (air electrode) side together with air not participating in the reaction, while carbon dioxide and methanol aqueous solution not participating in the reaction are discharged out of the negative electrode (fuel electrode) side.

Fuel feeding systems that have been proposed in such direct methanol fuel cells include external injection systems, in which undiluted methanol or a methanol aqueous solution are directly injected into the negative electrode (fuel electrode) side from outside the cell, via a syringe-like injector, or cartridge systems, in which a cartridge filled with undiluted methanol or a methanol aqueous solution is removably connected to the negative electrode (fuel electrode) of the fuel cell, and the undiluted methanol or the methanol aqueous solution is fed from the cartridge directly to the negative electrode (fuel electrode) side, so that, when a drop in the output of the fuel cell is observed, the cartridge is replaced by a new one. In both external injection and cartridge systems, however, the methanol fuel is held in a liquid state, and hence both are problematic in terms of handleability, on account of risks such as fuel splashing, leaking and the like during fuel feeding.

From the viewpoint of enhancing the output characteristics of direct methanol fuel cells, methanol aqueous solutions having a higher concentration are preferable. Methanol, however, is highly volatile and vaporizes readily at atmospheric pressure. Vaporized methanol can easily ignite in the presence of an ignition source, and thus both the use and transport of methanol pose safety problems. For these reasons the amount and/or concentration of methanol carried in means of transport, for instance in aircraft, is subject to regulatory restrictions. The regulatory restrictions on methanol in aircraft are an obstacle that hinders the commercial viability of direct methanol fuel cells. Although easing of such regulations is being advocated, there remain technical limits as regards reducing risks such as liquid leakage and so forth. Practical use of direct methanol fuel cells necessitates thus a highly safe fuel.

### DISCLOSURE OF THE INVENTION

### Problem to be Solved by the Invention

It is an object of the present invention to provide a method for producing a highly safe solid fuel for fuel cells having excellent handleability, and to provide a highly safe solid fuel for fuel cells having excellent handleability, as well as a fuel cell using such a solid fuel for fuel cells.

### Means for Solving the Problem

In order to solve the above problem, the present invention is a method for producing a solid fuel for fuel cells in which a coating film is formed on the surface of a porous material containing a fuel for fuel cells, wherein the coating film is formed by polyvinyl alcohol, and the fuel for fuel cells is introduced into the porous material before and/or after formation of the coating film on the surface of the porous material (Invention 1).

In the above invention (Invention 1), the coating film comprising polyvinyl alcohol and formed on the surface of the porous material containing fuel for fuel cells has the effect of suppressing vaporization of the fuel for fuel cells that is taken up in the porous material, inside the coating film, even under temperature conditions at which the fuel for fuel cells vaporizes. This allows producing a highly safe solid fuel for fuel cells having excellent handleability.

In the present description, the term “porous material” denotes generically a material having an irregular-shaped surface, and having holes, called pores, such that the depth of recessed portions is larger than the diameter of the pores, and such that liquid and gaseous substances can be introduced inside the pores.

In the above invention (Invention 1), the fuel for fuel cells is preferably an alcohol (Invention 2). In that invention (Invention 2), the alcohol is preferably methanol (Invention 3).

In the above inventions (Inventions 1 to 3), the porous material is preferably magnesium aluminometasilicate (Invention 4). Magnesium aluminometasilicate, whose specific surface area is extremely large even among porous materials, has a high holding ability, and can hence take up large amounts of solvents such as alcohol and water. There is thus virtually no change in appearance between magnesium aluminometasilicate having a solvent introduced into the pores thereof and the magnesium aluminometasilicate prior to introducing the solvent. The above invention (Invention 4), therefore, allows effectively introducing a fuel for fuel cells into a porous material, producing thereby a highly safe solid fuel for fuel cells having excellent handleability.

A further object of the invention is to provide a solid fuel for fuel cells wherein a coating film comprising polyvinyl alcohol is formed on the surface of a porous material containing a fuel for fuel cells (Invention 5).

In the above invention (Invention 5), the coating film comprising polyvinyl alcohol and formed on the surface of the porous material containing fuel for fuel cells has the effect of suppressing vaporization of the fuel for fuel cells that is taken up in the porous material, inside the coating film, even under temperature conditions at which the fuel for fuel cells vaporizes. As a result, a highly safe solid fuel for fuel cells having excellent handleability can be provided.

In the above invention (Invention 5), the fuel for fuel cells is preferably an alcohol (Invention 6), in particular methanol (Invention 7). Also, the porous material is preferably magnesium aluminometasilicate (Invention 8).

Yet another object of the present invention is to provide a fuel cell (Invention 9) comprising means for extracting a fuel for fuel cells from the solid fuel for fuel cells according to the above inventions (Inventions 5 to 8). In the invention (Invention 9), the extraction means may be means for bringing the solid fuel for fuel cells into contact with water (Invention 10), or means for heating the solid fuel for fuel cells (Invention 11). A further object of the present invention is to provide an electronic device (Invention 12) comprising the fuel cell according to the above inventions (Inventions 9 to 11).

### ADVANTAGEOUS EFFECT OF THE INVENTION

The present invention allows producing a highly safe solid fuel for fuel cells having excellent handleability.

### BRIEF DESCRIPTION OF THE DRAWINGS

FIG. 1 is a graph illustrating experimental results of thermogravimetry (TG) and differential thermal analysis (DTA) performed on solid methanol obtained in Example 1.

### BEST MODE FOR CARRYING OUT THE INVENTION

A method for producing the solid fuel for fuel cells according to an embodiment of the present invention is explained next.

To produce the solid fuel for fuel cells in the present embodiment, the fuel for fuel cells is introduced into the porous material, the obtained fuel-holding material is molded, and a coating film is formed on the molded fuel-holding material.

Examples of the fuel for fuel cells include, although not limited thereto, for instance alcohols, ethers, hydrocarbons, acetals, formic acid species or the like. As the fuel for fuel cells there can be used, specifically, lower aliphatic alcohols having 1 to 4 carbon atoms such as methanol, ethanol, denatured alcohol, 1-propanol, 2-propanol, 1-butanol, 2-butanol, tert-butanol and ethylene glycol; ethers such as dimethyl ether, methyl ethyl ether and diethyl ether; hydrocarbons such as propane and butane; acetals such as dimethoxymethane and trimethoxymethane; and formic acids such as formic acid and methyl formate. These may be used singly or in arbitrary combinations of two or more. Methanol, which is a fuel in direct methanol fuel cells, is preferably used among the foregoing.

The porous material can take up the fuel for fuel cells by being brought into contact with the fuel for fuel cells. The solid fuel for fuel cells can be produced by molding, to a predetermined shape, a fuel-holding material obtained by introducing the fuel for fuel cells into the porous material.

The porous material has an irregular-shaped surface, and has pores such that the depth of the surface depressions is larger than the pore diameter. The pore diameter of the porous material is not particularly limited, provided that the component of fuel for fuel cells can be introduced into the pores and can be held therein. The porous material may have pores classified into ultra-micropores having a pore diameter smaller than 0.5 nm, micropores having a pore diameter of 0.5 nm to less than 2 nm, mesopores having a pore diameter of 2 nm to less than 50 nm, or macropores having a pore diameter of 50 nm or larger. A porous material having pores of such pore diameters can effectively hold the fuel for fuel cells. The specific surface area of the porous material is preferably 100 to 1500 m²/g, while the bulk specific volume (tap) of the porous material is preferably 2.0 to 20 mL/g.

The porous material may be embodied, for instance, as a powder, particles, fibers, films, pellets or the like. The raw material from which the porous material is formed may be organic or inorganic, or a composite thereof.

Examples of the porous material include, for instance, silica gel, powder silica, zeolites, activated alumina, magnesium aluminometasilicate, activated carbon, molecular sieves, carbon, carbon fibers, activated clays, bone charcoal, porous glass; micropowders comprising inorganic oxides such as anodized aluminum oxide materials, titanium oxide or calcium oxide; perovskite oxides such as calcium titanate and sodium niobate; clays such as sepiolite, kaolinite, montmorillonite and saponite; and synthetic adsorption resins such as ion-exchange resins. These porous materials may be used singly or in combinations of two or more. The porous materials may also be used as hosts of a clathrate.

Among the foregoing, magnesium aluminometasilicate is preferably used as the porous material. The bulk specific volume of magnesium aluminometasilicate can be reduced depending on the producing method thereof. Accordingly, magnesium aluminometasilicate is suitably used in articles that must be compact, such as direct methanol fuel cells. Moreover, magnesium aluminometasilicate is a material also used as a raw material for digestive pharmaceutical preparations, and thus can be appropriately used by virtue of its proven safety for humans.

The fuel for fuel cells may be introduced into the porous material together with water. A solid fuel for fuel cells obtained by introducing water and a fuel for fuel cells into a porous material comprises a porous material having introduced therein a fuel for fuel-cells as a two-component system of water and a fuel for fuel cells. This has the effect, as a result, of reducing the vapor pressure and raising the flash point and the ignition point of the fuel for fuel cells, vis-à-vis the case when the fuel for fuel cells introduced in the porous material is a one-component system comprising the fuel for fuel cells alone. Therefore, vaporization of the fuel for fuel cells can be controlled even under such temperature conditions where a fuel for fuel cells ordinarily vaporizes, so that the solid fuel for fuel cells does not ignite even at the flash point of the fuel for fuel cells, thereby affording a solid fuel for fuel cells excellent in safety.

The amount of water introduced together with the fuel for fuel cells into the porous material may be small. Specifically, water may be blended in 0.01 to 1 parts by weight relative to 1 part by weight of fuel for fuel cells. Upon introducing a fuel for fuel cells together with water into a porous material, water may be introduced into the porous material having the fuel for fuel cells already introduced therein, or, alternatively, an aqueous solution of the fuel for fuel cells may be introduced into the porous material.

The method for introducing the fuel for fuel cells into the porous material is not particularly limited. A fuel-holding material in which a fuel for fuel cells is introduced into a porous material can be produced, for instance, by adding the porous material to the fuel for fuel cells, under sufficient stirring. In this case, the blending amount of porous material ranges preferably from 0.2 to 1 parts by weight relative to 1 part by weight of fuel for fuel cells. A porous material blending amount lying within the above amount range allows the fuel for fuel cells to be introduced effectively into the porous material, and allows molding effectively the fuel-holding material obtained by introducing the fuel for fuel cells into the porous material.

The temperature and pressure conditions during introduction of the fuel for fuel cells into the porous material are not particularly limited, and the fuel for fuel cells may be introduced into the porous material at normal temperature and pressure. A fuel-holding material in which a fuel for fuel cells is introduced into a porous material can be produced by mixing the fuel for fuel cells and the porous material at normal temperature and pressure, with sufficient stirring. When using a gaseous fuel as the fuel for fuel cells, the fuel for fuel cells is preferably introduced under pressure into the porous material.

The obtained fuel-holding material is molded to a predetermined shape. A molded fuel-holding material can be obtained as a result. Such a shape may be a suitable shape for the fuel cell in which the fuel for fuel cells is to be used, and may be, for instance, a defined-shape solid of spherical shape, quadrangular shape, cylindrical shape or the like, or of thin-film shape or fiber-like shape. A spherical shape is preferred among the foregoing. When the molded fuel-holding material is molded to a spherical shape, a coating film of homogeneous thickness can be formed on the surface of the molded fuel-holding material obtained by molding the fuel-holding material in the below-described step of forming a coating film. Accordingly, film thickness can be calculated easily on the basis of the quantitative relationship between the molded fuel-holding material and the coating agent used for forming the coating film. Calculating film thickness that way is advantageous from the viewpoint of quality control of the finished article.

For molding a fuel-holding material, the form of the fuel-holding material is preferably a powder. A fuel-holding material in the form of a powder can be easily molded to a predetermined shape (for instance granules, fibers, films, pellets or the like), and is thus preferable in terms of versatility.

The method for molding the obtained fuel-holding material is not particularly limited, and may involve, for instance, molding the fuel-holding material to a spherical shape using a binder or the like.

Examples of the binder include, for instance, starch, cornstarch, molasses, lactose, cellulose, cellulose derivatives, gelatin, dextrin, gum arabic, alginic acid, polyacrylic acid, glycerin, polyethylene glycol, polyvinyl alcohol (PVA), polyvinyl pyrrolidone (PVP), water, methanol, ethanol or the like. The foregoing may be used singly or in arbitrary combinations of two or more.

Since methanol is the fuel for fuel cells used in direct methanol fuel cells, the binder used is preferably methanol. With methanol there is also preferably used a material having the property of increasing viscosity when coming into contact with methanol, so that such thickening effect contributes to inter-particle binding. Such being the case, the binder used is preferably methanol and, for instance, a cellulose derivative, PVP or the like. The step of introducing methanol, as the fuel for fuel cells, into the porous material, may be omitted when using methanol as the binder. In this case, molding is carried out with methanol being added, as a binder, to the porous material, so that a molded fuel-holding material can be obtained while methanol, as the fuel for fuel cells, is being introduced into the porous material.

When using concomitantly methanol and a cellulose derivative or PVP as the binder, the blending ratio (weight basis) of methanol to the cellulose derivative or PVP is preferably 1000:1 to 10:1. A blending ratio within such a range allows molding the fuel-holding material effectively.

Methods for obtaining the molded fuel-holding material using the binder include, for instance, granulation molding, in which a viscous fluid obtained by bringing into contact methanol and a cellulose derivative or the like is added to the fuel-holding material or the porous material, or a method in which the cellulose derivative or the like, in unmodified powder form, is mixed with the fuel-holding material or the porous material, followed by granulation molding while adding methanol.

Specifically, the method for obtaining the molded fuel-holding material may be rolling granulation using a drum granulator, a disc granulator or the like; mixing-stirring granulation using a Flexomix, a vertical granulator or the like; extrusion granulation using a screw-type extrusion granulator, a roller-type extrusion granulator, a blade-type extrusion granulator, a self molding-type extrusion granulator or the like; compression granulation using a tableting granulator, a briquette type granulator or the like; and fluidized bed granulation, in which a binder is sprayed onto the fuel-holding material while the fuel-holding material is held in floating suspension within a fluid (mainly air) blown upwards, to granulate thereby the fuel-holding material. Given that an alcohol (methanol) is used as the binder, and that molding results in spherical shapes, the molded fuel-holding material is preferably molded by rolling granulation or mixing-stirring granulation.

The blending amount of binder is not particularly limited, but ranges preferably from 0.001 to 5 parts by weight relative to 1 part by weight of fuel-holding material or porous material. The fuel-holding material can be molded effectively when the blending amount of the binder lies within such a range.

Lastly, a coating film is formed on the surface of the molded fuel-holding material obtained by molding the fuel-holding material. A solid fuel for fuel cells can be produced thereby that allows controlling vaporization of the fuel for fuel cells held in the porous material, enclosed now within the formed coating film. Methods for forming a coating film on the surface of the molded fuel-holding material include, for instance, bringing a coating agent into contact with the molded fuel-holding material.

Polyvinyl alcohol (PVA) is used as the coating agent. PVA has excellent film formation action and forms effectively a coating film on the surface of the molded fuel-holding material, whereby vaporization of the fuel for fuel cells can be suppressed. PVA is widely used, for instance, in coatings of tablets and as an excipient in capsules and ointments in the medical field. Likewise, PVA is used as a raw material of a pack in the field of cosmetics, and is blended, as a thickener, into soap, creams and the like. PVA boasts thus proven safety for humans, and is hence appropriate in terms of safety, also in case of accidental ingestion by infants.

The PVA used as the coating agent may be a completely saponified polyvinyl alcohol or a partially saponified polyvinyl alcohol. The degree of saponification of the PVA ranges preferably from 70 to 100 mol %, in particular from 90 to 100 mol %. When the degree of saponification of the PVA lies within the above range, the fuel for fuel cells that is taken up in the porous material does not permeate readily through the film coating film of PVA. The vaporization of the fuel for fuel cells can thus be controlled.

The average degree of polymerization of the PVA ranges preferably from 200 to 1700, in particular from 200 to 500. An average degree of polymerization of the PVA lying within the above range allows limiting the viscosity of a PVA solution obtained by dissolving the PVA in a desired solvent, and facilitates the coating operation (in particular, a spray coating operation or the like).

Methods for forming a coating film on the surface of the molded fuel-holding material by bringing into contact the molded fuel-holding material and a coating agent include, but not limited thereto, for instance fluidized bed coating, coating by combined rolling and fluidizing, drum coating, pan coating or the like. Coating may involve film coating, sugar coating or the like, but preferably film coating, from the viewpoint of making the formed coating film as thin as possible, to increase the methanol content in the solid fuel for fuel cells.

The blending amount of the coating agent ranges preferably from 0.0001 to 0.1 parts by weight relative to 1 part by weight of molded fuel-holding material. When the blending amount of coating agent falls within the above range the coating film can be effectively formed, to a desired thickness, on the surface of the molded fuel-holding material.

In the above embodiment, a coating film comprising PVA is formed on the surface of the porous material (molded fuel-holding material) after the fuel for fuel cells has been introduced in the porous material. However, the fuel for fuel cells may also be introduced in the porous material after the coating film comprising PVA has been formed on the surface of the porous material. Alternatively, part of the fuel for fuel cells may be introduced into the porous material, then a coating film comprising PVA may be formed on the surface of the porous material, after which the remainder of the fuel for fuel cells is introduced into the porous material.

In this case, the porous material having formed thereon a coating film comprising PVA may be left to stand in an environment in the presence of the fuel for fuel cells, to allow the porous material to take up thereby the fuel for fuel cells. Alternatively, the fuel for fuel cells may be injected, using a syringe or the like, into the porous material having formed thereon a coating film comprising PVA.

Preferably, the solid fuel for fuel cells thus obtained has introduced therein 1 to 3 parts by weight of fuel for fuel cells relative to 1 part by weight of porous material. When obtained by introducing water and fuel for fuel cells into a porous material, the solid fuel for fuel cells has preferably introduced therein a total 1 to 3 parts by weight of fuel for fuel cells and water relative to 1 part by weight of porous material.

Methods for extracting the fuel for fuel cells from the solid fuel for fuel cells produced in accordance with the present embodiment include, for instance, a method that involves vaporizing the fuel for fuel cells out of the solid fuel for fuel cells by heating the solid fuel for fuel cells, to extract thereby the fuel for fuel cells in gaseous form, or a method that involves extracting the fuel for fuel cells in the form of an aqueous solution out of the solid fuel for fuel cells, by bringing the solid fuel for fuel cells into contact with water.

When the fuel for fuel cells is extracted by heating the solid fuel for fuel cells, the heating temperature ranges preferably from 20 to 100° C., in particular from 40 to 80° C. When the heating temperature lies within the above range the amount of fuel supplied to the fuel cell can be controlled based on the temperature, which is advantageous from the viewpoint of fuel cell operation.

Given that the solid fuel for fuel cells is used in a direct methanol fuel cell, the fuel for fuel cells is preferably extracted from the solid fuel for fuel cells by bringing the solid fuel for fuel cells into contact with water. Doing so allows extracting the fuel for fuel cells in the form of a fuel aqueous solution, whereby the fuel aqueous solution can be supplied directly to the negative electrode (fuel electrode) of the fuel cell, which exhibits as a result excellent energy characteristics.

The fuel cell in which the solid fuel for fuel cells is used is not particularly limited, and may be, for instance, a direct methanol fuel cell, a polymer electrolyte fuel cell, a solid oxide fuel cell or the like.

The fuel cell comprises means for extracting the fuel for fuel cells from the solid fuel for fuel cells. Such means that allow extracting fuel for fuel cells from the solid fuel for fuel cells may be configured, for instance, so as to vaporize the fuel for fuel cells out of the solid fuel for fuel cells by heating the solid fuel for fuel cells, or so as to bring the solid fuel for fuel cells into contact with water, filter the porous material, and extract the fuel for fuel cells in the form of an aqueous solution.

The solid fuel for fuel cells obtained in accordance with the present embodiment has excellent safety in that, if the fuel cell body is damaged as a result of an unexpected situation, the solid fuel for fuel cells does not diffuse as a liquid fuel would, nor does it irritate the skin should it come into contact with hands or feet.

In a solid fuel for fuel cells obtained by introducing water and a fuel for fuel cells into a porous material, and having formed a coating film on the surface, moreover, the flash point and the ignition point of the solid fuel for fuel cells is higher than the flash point and the ignition point of the fuel for fuel cells. This allows controlling the vaporization of the fuel for fuel cells. Safety and stability during storage of the fuel for fuel cells can be improved as a result, while handling of the fuel for fuel cells can also be made easier thereby.

Such a fuel cell can be suitable used as a power source of portable electronic devices, such as mobile phones, notebook computers, digital cameras or the like, by electrically connecting the fuel cell to the portable electronic device.

The embodiments explained above are described to facilitate understanding of the present invention and is not to limit the present invention. Accordingly, respective elements disclosed in the above embodiments include all design modifications and equivalents belonging to the technical scope of the present invention.

For instance, in the embodiment described above, there may be omitted the step of molding to a predetermined shape the fuel-holding material comprising a porous material having a fuel for fuel cells introduced therein.

### EXAMPLES

The present invention is explained in detail next based on examples, although the present invention is in no way meant to be limited to or by these examples.

### Example 1

A spherical granulate was prepared in a mixing-stirring granulator (VG-01, by Powrex Co.) where 270 g of methanol, as a binder, were added to 80 g of magnesium aluminometasilicate. Next, 150 g of the obtained fuel-holding material were charged into a pan coating machine (DRC-200, by Powrex Co.), and 200 g of coating solution (5 wt % aqueous solution of polyvinyl alcohol (degree of saponification of PVA: 99 mol %, average degree of polymerization of PVA: 300)) were sprayed onto the surface of the fuel-holding material, followed by drying, to form a coating film and yield thereby solid methanol (Sample 1). The obtained solid methanol was further soaked in methanol, was removed and was dried.

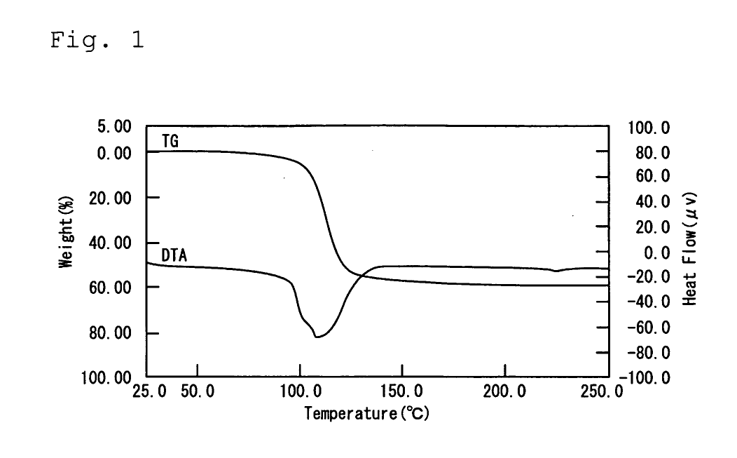

The obtained solid methanol (Sample 1) was set in a high-sensitivity differential scanning calorimeter (Thermo Plus 2, by Rigaku Co.), and was subjected to a differential thermal analysis (DTA) to measure the thermogravimetric (TG) change that accompanies the vaporization of methanol, for a rise in temperature from room temperature to 250° C. with a temperature rise rate of 10° C./min, and to observe the process of thermal change of the solid methanol (Sample 1). The results are shown in FIG. 1.

As shown in the TG curve of FIG. 1, virtually no decrease in the weight of solid methanol (Sample 1) was observed up to around 65° C., which is the boiling point of methanol. The weight decreased gradually beyond the boiling point, and dropped abruptly between 95 to 120° C. The thermogravimetric change was of −53.64% at 150° C., where no further thermogravimetric change was observed. This suggests that the methanol content in the solid methanol (Sample 1) obtained in Example 1 is 53.64 wt %. The endothermic reaction of the solid methanol (Sample 1), which proceeded on account of methanol vaporization accompanying the rising temperature, peaked at an observed endothermic peak of 112.9° C.

The flash point of the solid methanol (Sample 1) obtained in Example 1 was measured in accordance with the “Setaflash closed-cup flash point test method”, which is an assessment test method for hazardous materials prescribed in the “Government Ordinances on Testing and Characterization of Hazardous Materials”. Since the fuel for fuel cells is vaporized at the flash point, measuring the flash point of the sample allows verifying whether vaporization of the fuel for fuel cells can be controlled or not.

The flash point of the solid methanol (Sample 1) obtained in Example 1 was 48° C., which is higher than the flash point of 40° C. that corresponds to flammable solids in Class 2 of hazardous materials. The solid methanol (Sample 1) obtained in the present example was thus found to be a non-hazardous material. This showed that the solid methanol (solid fuel for fuel cells) obtained in the present example is capable of controlling vaporization of methanol, as the fuel for fuel cells.

### Comparative Example 1

The flash point of undiluted methanol was measured in accordance with the “tag closed-cup flash point test method (JIS-K2265-1996, Test Methods for the Flash Point of Crude Oil and Petroleum Products)”, which is a method for measuring the flash point of liquids. The flash point of the undiluted methanol was 11° C.

These results show that a highly safe solid fuel for fuel cells can be obtained by introducing methanol in magnesium aluminometasilicate and by forming thereon a coating film comprising PVA, as in Example 1.

### INDUSTRIAL APPLICABILITY

The method for producing a solid fuel for fuel cells of the present invention is useful for producing a highly safe solid fuel for fuel cells that is easy to handle.

1. A method for producing a solid fuel for fuel cells in which a coating film is formed on the surface of a porous material containing a fuel for fuel cells,
wherein said coating film is formed by polyvinyl alcohol, and
said fuel for fuel cells is introduced into said porous material before and/or after formation of said coating film on the surface of said porous material.

2. The method for producing a solid fuel for fuel cells according to claim 1, wherein said fuel for fuel cells is an alcohol.

3. The method for producing a solid fuel for fuel cells according to claim 2, wherein said alcohol is methanol.

4. The method for producing a solid fuel for fuel cells according to claim 1, wherein said porous material is magnesium aluminometasilicate.

5. A solid fuel for fuel cells, wherein a coating film comprising polyvinyl alcohol is formed on the surface of a porous material containing a fuel for fuel cells.

6. The solid fuel for fuel cells according to claim 5, wherein said fuel for fuel cells is an alcohol.

7. The solid fuel for fuel cells according to claim 6, wherein said alcohol is methanol.

8. The solid fuel for fuel cells according to claim 5, wherein said porous material is magnesium aluminometasilicate.

9. A fuel cell, comprising means for extracting a fuel for fuel cells from the solid fuel for fuel cells according to claim 5.

10. The fuel cell according to claim 9, wherein said extraction means is means for bringing said solid fuel for fuel cells into contact with water.

11. The fuel cell according to claim 9, wherein said extraction means is means for heating said solid fuel for fuel cells.

12. An electronic device, comprising the fuel cell according to claim 9.
